(19) United States
(12) Patent Application Publication
(10) Pub. No.: US 2011/0267383 A1
(43) Pub. Date: Nov. 3, 2011

(54) LIQUID CRYSTAL DISPLAY DEVICE AND DRIVING METHOD THEREOF

(75) Inventors: Hirofumi Murakami, Osaka (JP); Yuhji Tanaka, Osaka (JP); Shinji Horino, Osaka (JP)

(73) Assignee: Sharp Kabushiki Kaisha, Osaka-shi (JP)

(21) Appl. No.: 13/138,073

(22) PCT Filed: Feb. 9, 2010
(86) PCT No.: PCT/JP2010/000767

§ 371 Date: Jun. 30, 2011

(30) Foreign Application Priority Data
May 19, 2009 (JP) 2009-121458

(51) Int. Cl. G09G 3/36; G09G 5/10

(52) U.S. Cl. 345/690; 345/89

(57) ABSTRACT

An object of at least one embodiment of the present invention is to provide a liquid crystal display device and a driving method thereof, in which a contour of an image is clearly recognized during movie display even in a case where a backlight is turned on and off so as to change intervals at which the backlight turns on. In at least one embodiment, the liquid crystal display device includes a liquid crystal panel and the backlight that irradiates the liquid crystal panel with light, one frame period including a turn-on period during which the backlight turns on and a turn-off period during which the backlight turns off, luminance being changed by changing turn-on intervals of the backlight, the turn-on intervals of the backlight being changed by changing lengths of the turn-on period and the turn-off period. The liquid crystal display device further includes an OS process circuit for controlling a drive voltage to be applied to the liquid crystal panel by setting an amplitude of the drive voltage to be applied to the liquid crystal panel during a gray scale transition. The OS process circuit sets the amplitude of the drive voltage to be applied to the liquid crystal panel during the gray scale transition so as to be greater as the turn-on period of the backlight is longer under a condition where gray scales that have not been subjected to a gray scale transition is equal to gray scales that have been subjected to the gray scale transition in a case where the turn-on period of the backlight varies.

### TECHNICAL FIELD

The present invention relates to a liquid crystal display device that changes luminance by turning on and off a backlight so as to change intervals at which the backlight turns on, and relates to a method for driving the liquid crystal display device.

### BACKGROUND ART

Conventionally, there have been known, as display devices, an impulse-type display device such as a CRT (cathode-ray tube) and a hold-type display device such as a liquid crystal display device.

According to the impulse-type display device, pixels in each of which a turn-on period during which an image is displayed on each pixel and a turn-off period during which an image is not displayed on the each pixel are alternated. For example, in a case where a moving image is displayed, a turn-off period is inserted when an image corresponding to one (1) screen is changed. Therefore, a viewer will never recognize any after-image of a moving object. This allows the viewer to clearly distinguish between a background and the moving object, thereby recognizing the moving image without feeling odd.

Meanwhile, according to the hold-type display device, each luminance of pixels is retained for one (1) frame period (one (1) vertical period) during which an image corresponding to one (1) screen is changed. In a case where a moving image is displayed in the hold-type display device, a viewer recognizes an after-image of a moving object. Specifically, the viewer recognizes a vague outline of the moving object. Such a phenomenon is called, for example, moving image blur. It is considered that the moving image blur is caused by followability of the viewer's visual axis.

The hold-type display device thus causes the moving image blur during displaying of the moving image. Therefore, the impulse-type display device is often employed as a display such as a TV (television) where a moving image is displayed.

Meanwhile, recently, reductions in thickness and in weight of a display such as a TV have been strongly requested. Therefore, the hold-type display device, which can easily achieve the reductions in lightweight and in thickness, has been rapidly employed as such a display.

Among others, a liquid crystal display device is characterized in reduction in thickness, lightweight and low power consumption. As such, such a liquid crystal display device has been recently and widely employed, instead of the CRT, in various fields such as a TV, a monitor, a mobile device such as a mobile phone.

However, the liquid crystal display device generally has a very slow response speed, as compared with other display devices such as the CRT. In the liquid crystal display device, a display gray scale is changed as follows. Namely, a change in voltage, applied across a liquid crystal layer, causes a change in alignment states of liquid crystal molecules so as to cause a change in transmittance of a display pixel. The response speed of the liquid crystal display device is in proportion to the inverse of time (response time) necessary for the alignment state of the liquid crystal layer to reach an alignment state corresponding to the applied voltage.

Note, however, that it takes some time for the liquid crystal layer to reach the alignment state corresponding to the applied voltage. For example, in a case where a liquid crystal panel that is compatible with a double speed tries to rewrite 120 times per second, it takes 2 or more frames for the liquid crystal panel to respond.

Therefore, a recent liquid crystal display device which has (i) a short driving period (writing period) per pixel and (ii) a large screen size or a high definition may cause a problem that a desired display gray scale can not be achieved because changes in the alignment states of the liquid crystal molecules fail to follow, within a writing period, a change in an applied voltage.

In order to address the problem, there has been recently proposed, as a technique for improving a response speed of liquid crystal, a method for driving a liquid crystal display device (gray scale transition emphasis process) which is called overshooting drive (overdrive) (see, for example, Patent Literature 1).

The gray scale transition emphasis process (hereinafter referred to as “OS drive”) is a drive method for improving the response speed by applying an emphasis voltage to a liquid crystal panel so as to increase the response speed of liquid crystal.

According to the OS drive, a change in alignments of the liquid crystal molecules is promoted as follows. Specifically, in a case of a transition from a current gray scale to a next gray scale which is higher than the current gray scale, a voltage (gray scale voltage, drive voltage), which is greater than a write voltage (gray scale voltage) corresponding to a gray scale to be displayed, is applied for a predetermined period. In contrast, in a case of a transition from a current gray scale to a next gray scale which is lower than the current gray scale, a voltage, which is smaller than a write voltage corresponding to a gray scale to be displayed, is applied for the predetermined period.

Such an OS drive is generally realized by converting an input gray scale by use of a look-up table (LUT).

FIG. 8 is a block diagram schematically showing a configuration of a general overshoot process circuit (hereinafter referred to as “OS process circuit”) for performing the OS driving.

As shown in FIG. 8, an OS process circuit 111 includes a frame buffer 112 (frame memory), a gray scale conversion section 113, and an LUT memory 114 in which an LUT is stored.

The LUT memory 114 stores an LUT in which a converted correction gray scale is associated with a combination of a gray scale of a current frame (current vertical period) and a gray scale of a next frame (one (1) vertical period) which comes one (1) frame after the current frame.

The frame buffer 112 receives a video signal (video data signal, gray scale data) from a video creation device (not shown). The frame buffer 112 holds the video signal for one (1) frame period (that is, until the frame buffer 112 receives a video signal for a next frame). Namely, the frame buffer 112 holds a video signal of a previous frame (input image of a previous vertical period).

The gray scale conversion section 113 receives (i) a video signal of a current frame from the video creation device (not shown) and (ii) the video signal of the previous frame read from the frame buffer 112. The gray scale conversion section 113 reads, from the LUT, an output gray scale (a converted correction gray scale) corresponding to the video signal of the current frame and the video signal of the previous frame, and then outputs the output gray scale as a liquid crystal panel drive signal to a liquid crystal panel drive circuit for driving the liquid crystal panel.

(a) of FIG. 9 is a timing chart (a waveform diagram) showing input and output signals obtained in cases where the OS drive is not performed, and (b) of FIG. 9 is a timing chart (a waveform diagram) showing input and output signals obtained in cases where the OS drive is performed. Each of (a) and (b) of FIG. 9 further shows (i) a waveform of transmittance of liquid crystal, (ii) a waveform of values obtained by integrating, over a time period during which the backlight turns on, the product (indicated by “PRODUCT OF BACKLIGHT AND TRANSMITTANCE” in FIG. 9) of transmittance of liquid crystal and an intensity of the backlight obtained when the backlight turns on, and (iii) a waveform (an outline of a moving object in a movie display) showing how an image is actually viewed on a liquid crystal panel. It is noted in the following description that “no OS” indicates a case where the OS drive is not performed, whereas “OS” indicates a case where the OS drive is performed. (a) of FIG. 9 shows the timing chart obtained in a case of “no OS”, and (b) of FIG. 9 shows the timing chart obtained in a case of “OS”.

In the case where the liquid crystal panel drive circuit performs the OS drive, the liquid crystal panel drive circuit drives the liquid crystal display device in response to the liquid crystal panel drive signal (drive voltage, gray scale voltage) supplied from the OS process circuit 111. This causes the liquid crystal panel to receive a great electric potential difference at a point where display data changes, as shown in (b) of FIG. 9. Such a correction makes it possible to increase the response speed of the liquid crystal display device as shown in (b) of FIG. 9, compared to a case where the liquid crystal panel drive circuit does not perform the OS drive.

### Citation List

Patent Literature

Patent Literature 1

Japanese Patent Application Publication, Tokukai No. 2001-343956 A (Publication Date: Dec. 14, 2001)

### SUMMARY OF INVENTION

### Technical Problem

A liquid crystal display device, however, causes a problem of occurring moving image blur in a case where a moving image is displayed. This is because (i) the response of liquid crystal is low and (ii) the hold drive is employed as a drive method of the liquid crystal display device.

The OS drive as shown in (b) of FIG. 9 shortens a period during which an intermediate gray scale is displayed, compared to a case where the OS drive is not performed. Note, however, that the intermediate gray scales, which are not included in an original gray scale, appear at a point where display data changes, regardless of whether or not the OS drive is performed (see (a) and (b) of FIG. 9). The appearance of the intermediate gray scales at the point where the display data changes causes a viewer to recognize a vague outline of a moving object.

In addition to the technique for improving the response speed by use of the OS drive, there has been recently proposed, as a technique for suppressing moving image blur caused by the hold drive, a drive method referred to as a pseudo impulse drive in which impulse drive is carried out in a hold-type liquid crystal display device. According to the pseudo impulse drive, a turn-on period during which an image is displayed and a turn-off period during which no image is displayed are alternated, by inserting the turn-off period in one (1) frame period so that a backlight turns on and off.

Inventors of the present application combined the pseudo impulse drive with the OS drive so that an emphasis voltage is applied to a liquid crystal panel while turning on and off the backlight.

Specifically, the inventors of the present application employed a liquid crystal display system, shown in FIG. 10, in which a video signal was inputted from a video creation device 101 to an OS process circuit 111 (see FIG. 8) of a liquid crystal display device 102 while a backlight turn-on signal was inputted to a backlight 131 provided behind a liquid crystal panel 121 so that the backlight 131 turned on and off.

As a result, the inventors of the present application found that how the image displayed on the liquid crystal panel was viewed at the point where the display data changed varied depending on a turn-on period of the backlight. This is described below in detail.

(a) through (c) of FIG. 11 are timing charts (waveform diagrams) showing how an image is actually viewed on the liquid crystal panel depending on the turn-on period of the backlight, input and output signals, transmittance of the liquid crystal, a waveform (indicated by “PRODUCT OF BACKLIGHT AND TRANSMITTANCE” in FIG. 11) of values obtained by integrating, over the time period during which the backlight turns on, the product of the transmittance of the liquid crystal and an intensity of the backlight obtained when the backlight turns on.

According to the pseudo impulse drive, the backlight is periodically turned on and off at predetermined time intervals while an image is being displayed. In a case where the backlight was thus turned on and off at the predetermined time intervals, that is, in a case where luminance of the backlight was constant, the image could be properly displayed as shown in (a) of FIG. 11 by (i) obtaining a drive voltage Of the liquid crystal panel on the basis of a video signal of a current frame and a video signal of a previous frame which came one (1) frame before the current frame and (ii) applying a great electric potential difference at the point where the display data changed.

However, as shown in (b) and (c) of FIG. 11, in a case where the turn-on period of the backlight 131 was increased so that the luminance of the backlight 131 was changed while the transmittance of the liquid crystal was not changed from a state shown in (a) of FIG. 11, it was found that the viewer could not clearly recognize an outline of the moving object (contour of an image) during a movie display because the viewer recognized (i) an outline of a different gray scale (intermediate gray scale) and (ii) an outline of a displayed moving image of a moving object. This is because, in a case where the turn-on period of the backlight is merely changed without changing the transmittance of the liquid crystal as shown in (a) through (c) of FIG. 11, a value, obtained by integrating the transmittance of the liquid crystal over the turn-on period, changes, and therefore the viewer recognizes, at the point where the display data changes, the intermediate gray scales which are not included in the original gray scale.

The present invention can solve a problem newly found by changing intervals at which the backlight turns on in a case where the emphasis voltage is applied to the liquid crystal panel while the backlight is turned on and off as above described. That is, an object of the present invention is to provide a liquid crystal display device and a driving method thereof, in which the viewer can clearly recognize the contour of the image of the moving image during the movie display even in a case where the backlight is turned on and off so as to change the turn-on intervals of the backlight.

### Solution to Problem

A liquid crystal display device of the present invention, in order to attain the object, includes: a liquid crystal panel; and a backlight that irradiates the liquid crystal panel with light, one frame period including a turn-on period during which the backlight turns on and a turn-off period during which the backlight turns off, luminance being changed by changing turn-on intervals of the backlight, said liquid crystal display device, further comprising: a control circuit which controls a drive voltage to be applied to the liquid crystal panel by setting an amplitude of the drive voltage to be applied to the liquid crystal panel during a gray scale transition, the control circuit setting the amplitude of the drive voltage so as to be greater as the turn-on period of the backlight is longer under a condition where a gray scale that has not been subjected to a gray scale transition is equal to a gray scale that has been subjected to the gray scale transition.

Further, a method for driving the liquid crystal display device of the present invention is a method for driving a liquid crystal display device including: a liquid crystal panel, and a backlight that irradiates the liquid crystal panel with light, said method, comprising the steps of: causing one frame period to include a turn-on period during which the backlight turns on and a turn-off period during which the backlight turns off; changing luminance by changing turn-on intervals of the backlight; and setting the amplitude of the drive voltage, to be applied to the liquid crystal panel during a gray scale transition, to be greater as the turn-on period of the backlight is longer under a condition where a gray scale that has not been subjected to a gray scale transition is equal to a gray scale that has been subjected to the gray scale transition.

According to the above-described arrangement and method, it is possible not only to attain low power consumption but also to suppress occurrence of moving image blur due to hold drive during the gray scale transition by inserting the turn-out period in the one (1) frame period.

Further, it is possible to reduce appearance of an outline of a different gray scale (intermediate gray scale different from an original gray scale) in an outline of a moving object by applying an emphasis voltage to the liquid crystal panel as described above in a case where the backlight is turned on and off so as to change intervals at which the backlight turns on. Therefore, according to the above arrangement, it is possible to provide a liquid crystal display device and a driving method thereof, in which a viewer can clearly recognize the outline of the moving object (a contour of an image) during movie display even in a case where the luminance is changed by changing the turn-on intervals of the backlight.

### Advantageous Effects of Invention

According to the present invention, in a case where luminance is changed by changing turn-on intervals of a backlight, an amplitude of a drive voltage, which is applied to a liquid crystal panel during a gray scale transition on the assumption that identical evaluation criteria are employed, becomes stronger as a turn-on period of the backlight is longer. Namely, the amplitude of the drive voltage, which is applied to the liquid crystal panel during the gray scale transition under a condition where a gray scale that has not been subjected to a transition is equal to a gray scale that has been subjected to the transition, is increased as the turn-on period of the backlight is longer.

On this account, the present invention makes it possible not only to attain low power consumption but also reduce appearance of an outline of a different gray scale (intermediate gray scale different from an original gray scale) in an outline of a moving object during movie display even in the case where the luminance is changed by changing the turn-on intervals of the backlight. Therefore a viewer can clearly recognize the outline of the moving object (contour of an image).

### BRIEF DESCRIPTION OF DRAWINGS

FIG. 1

FIG. 1 is a block diagram schematically showing a configuration of a liquid crystal display system in accordance with an embodiment of the present invention.

FIG. 2

FIG. 2 is a block diagram schematically showing a configuration of an overshoot process circuit in accordance with an embodiment of the present invention.

FIG. 3 is a view showing how an LUT memory shown in FIG. 2 stores a plurality of look-up tables.

FIG. 4 is a view showing an example of the look-up tables stored in the LUT memory shown in FIG. 3.

FIG. 5

(a) to (c) of FIG. 5 are timing charts each showing input and output signals in the liquid crystal display system shown in FIG. 1, a waveform of transmittance of liquid crystal, a waveform of values obtained by integrating, over a time period during which the backlight turns on, the product of the transmittance of the liquid crystal and an intensity of the backlight obtained when the backlight turns on, and a waveform showing how an image is actually viewed on a liquid crystal panel.

FIG. 6

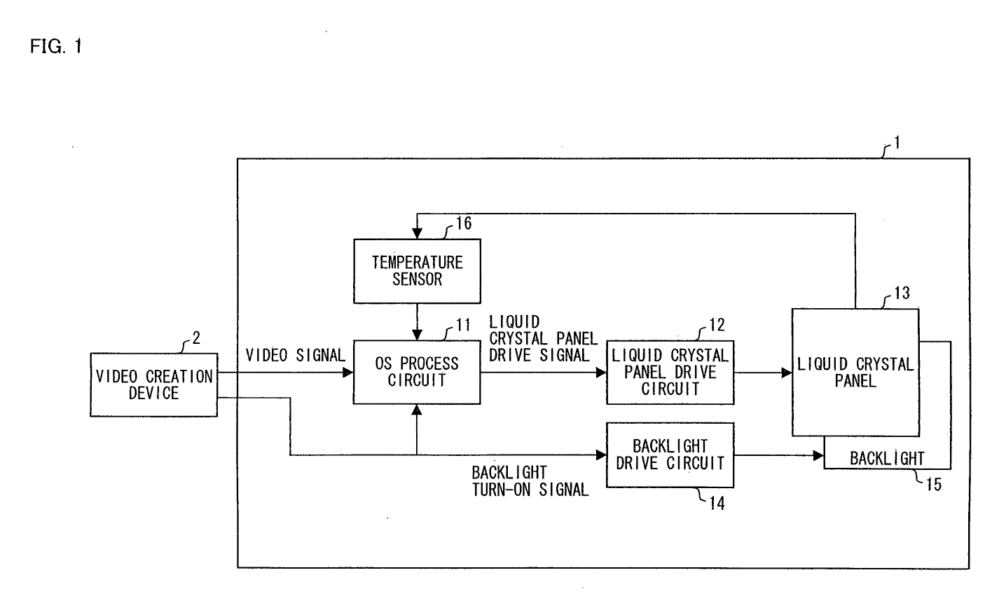

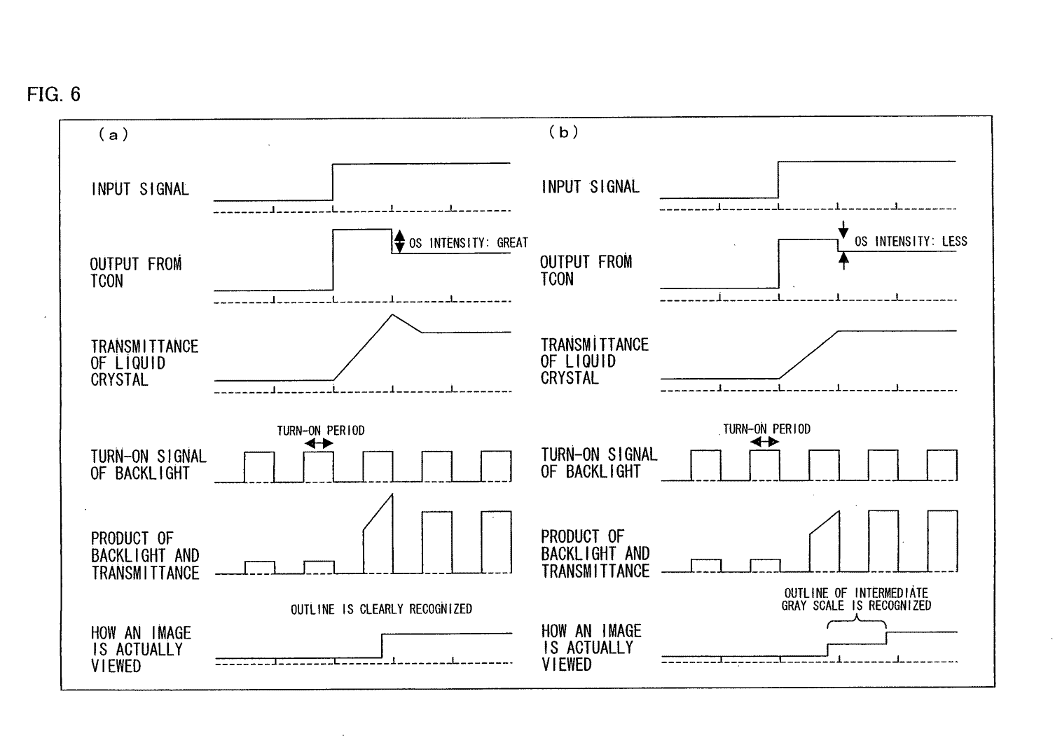

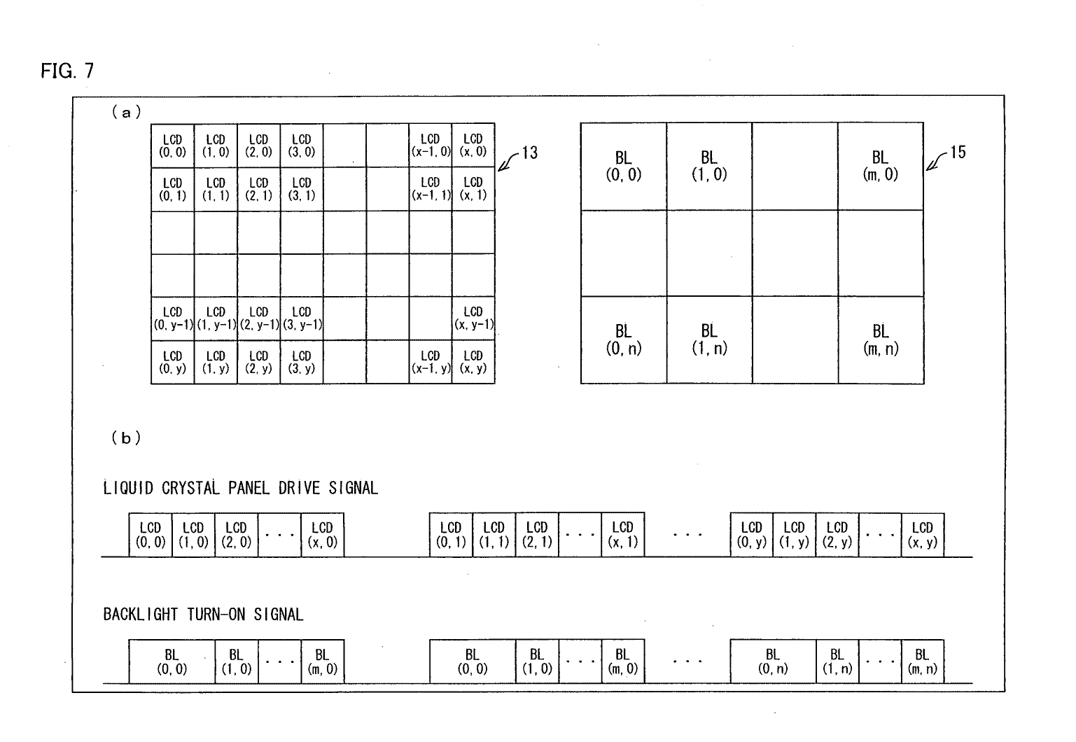

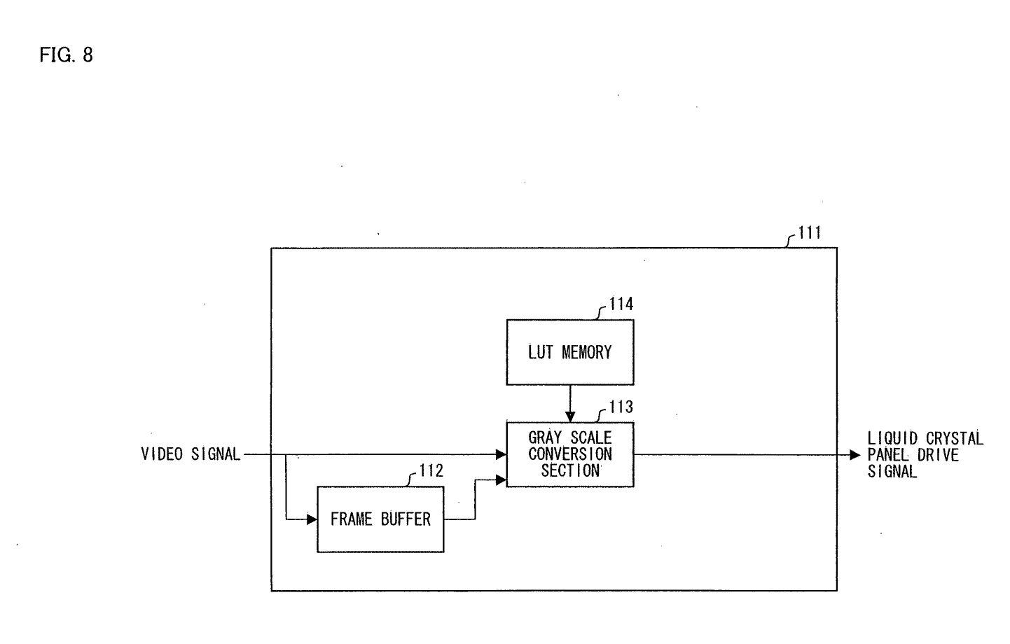

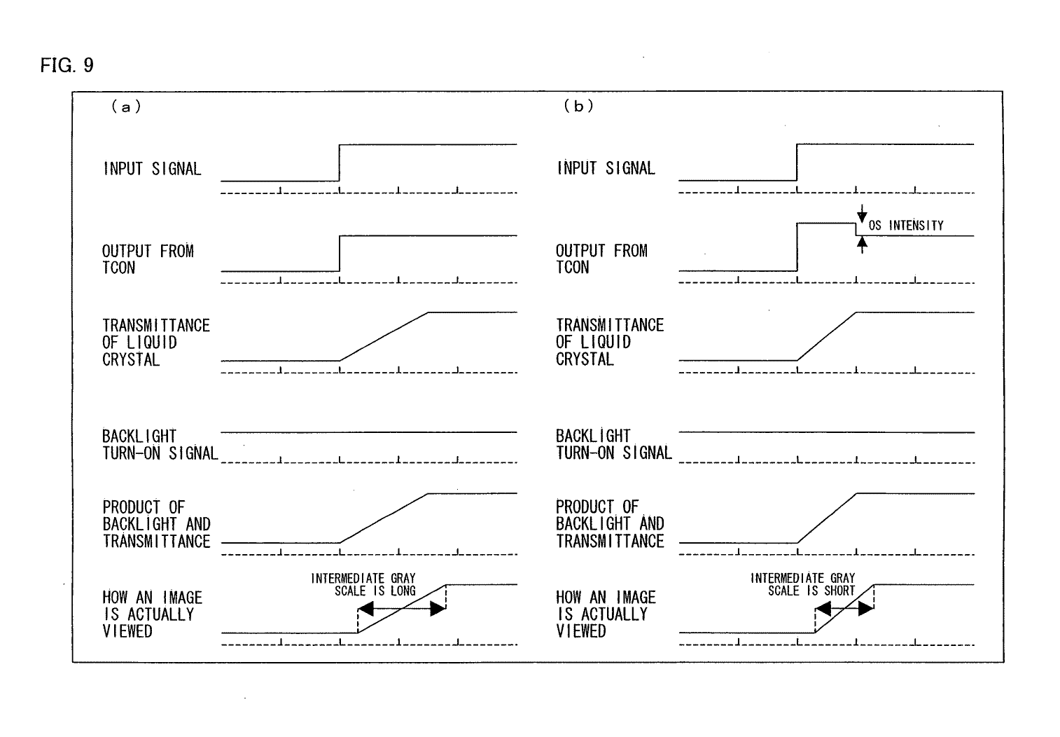

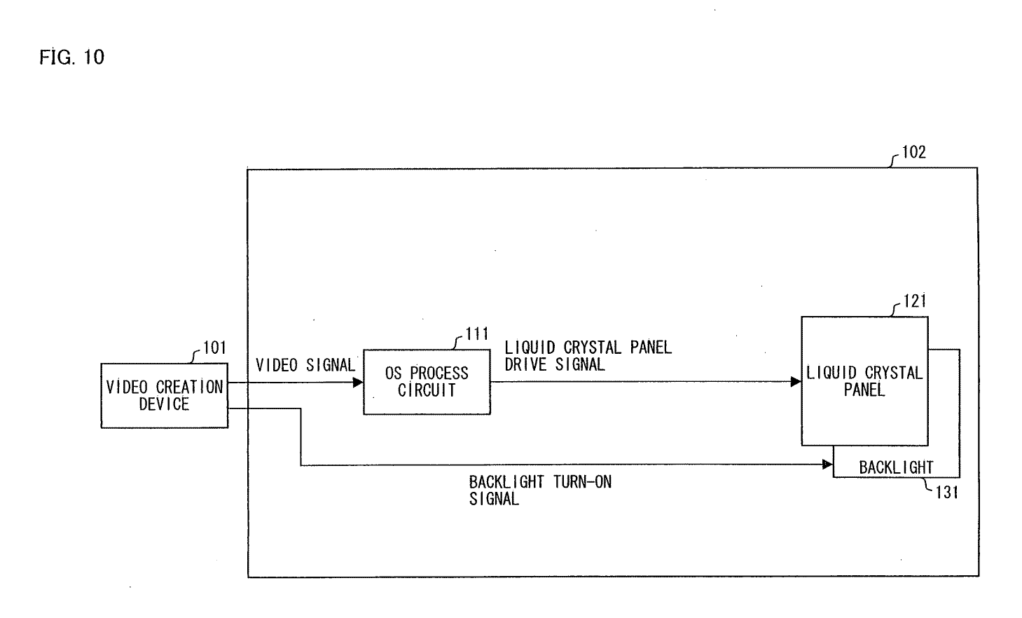

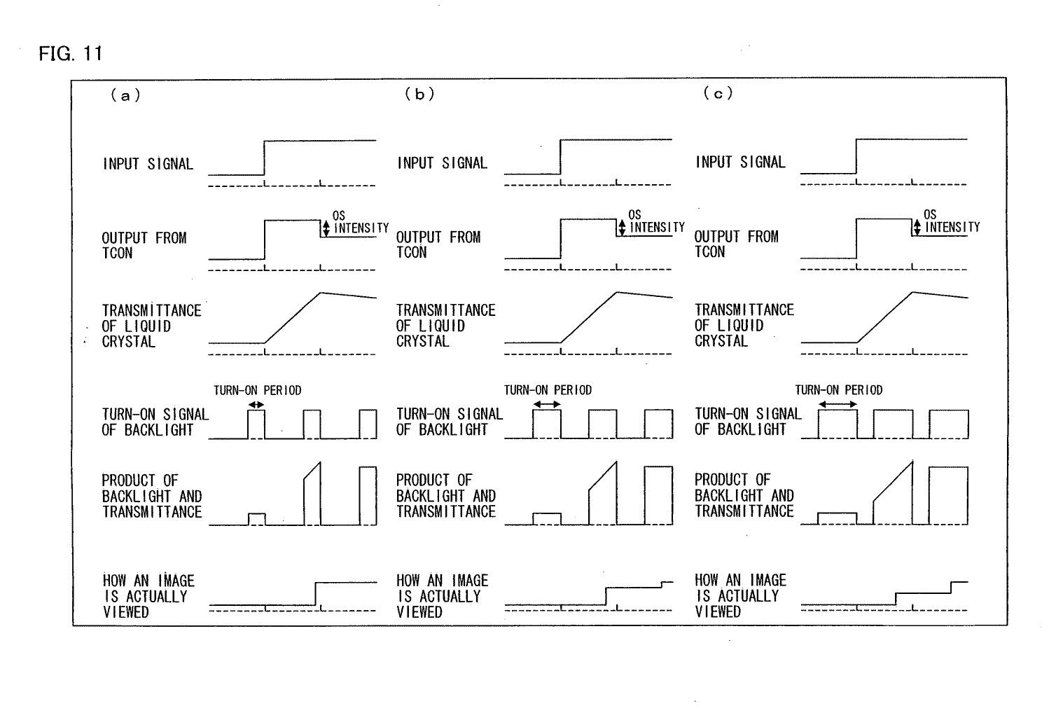

(a) of FIG. 6 is a timing chart showing input and output signals in the liquid crystal display system shown in FIG. 1, and (b) of FIG. 6 is a timing chart showing input and output signals in a liquid crystal display system shown in FIG. 10. Each of (a) and (b) of FIG. 6 further shows (i) a waveform of transmittance of liquid crystal, (ii) a waveform of values obtained by integrating, over a time period during which the backlight turns on, the product of the transmittance of the liquid crystal and an intensity of the backlight obtained when the backlight turns on, and (iii) a waveform showing how an image is actually viewed on a liquid crystal panel.

FIG. 7

(a) of FIG. 7 shows pixels of a liquid crystal panel and divided regions of a backlight. (b) of FIG. 7 shows liquid crystal panel drive signals and backlight turn-on signals indicating turn-on periods of the respective regions of the backlight.

FIG. 8

FIG. 8 is a block diagram schematically showing a configuration of a general overshoot process circuit.

FIG. 9

(a) of FIG. 9 are a timing chart showing input and output signals obtained in cases where an OS drive is not performed, and (b) of FIG. 9 is a timing chart showing input and output signals obtained in cases where the OS drive is performed. Each of (a) and (b) of FIG. 9 further shows (i) a waveform of transmittance of liquid crystal, (ii) a waveform of values obtained by integrating, over a time period during which the backlight turns on, the product of the transmittance of the liquid crystal and an intensity of the backlight obtained when the backlight turns on, and (iii) a waveform showing how an image is actually viewed on a liquid crystal panel.

FIG. 10

FIG. 10 is a block diagram schematically showing a configuration of a liquid crystal display system employed for measurement shown in FIG. 11.

FIG. 11

(a) to (c) of FIG. 11 are timing charts showing how an image is actually viewed on a liquid crystal panel depending on a turn-on period of a backlight, input and output signals, transmittance of liquid crystal, a waveform of values obtained by integrating, over the turn-on period of the backlight, the product of the transmittance of the liquid crystal and an intensity of the backlight obtained when the backlight turns on.

### DESCRIPTION OF EMBODIMENTS

The following describes in detail an embodiment of the present invention.

FIG. 1 is a block diagram schematically showing a configuration of a liquid crystal display system in accordance with the present embodiment.

The liquid crystal display system shown in FIG. 1 includes a liquid crystal display device 1 and a video creation device 2.

The liquid crystal display device 1 shown in FIG. 1 includes an overshoot process circuit (hereinafter referred to as “OS process circuit”) 11 for carrying out a gray scale transition emphasis process (hereinafter referred to as “OS drive”) referred to as what is called overshoot drive (overdrive), a liquid crystal panel drive circuit 12, a liquid crystal panel 13, a backlight drive circuit 14, a backlight 15, a temperature sensor 16, and a timing control circuit (TCON) that is not shown in FIG. 1.

The video creation device 2 supplies, to the liquid crystal display device 1, (i) a video signal (video data signal) and (ii) a backlight turn-on signal (backlight control signal) indicative of backlight turn-on information such as a turn-on period of the backlight 15.

The timing control circuit creates timing control signals such as a clock signal and a start pulse. The liquid crystal display device 1 operates in response to the timing control signals. The video signal and the backlight turn-on signal are supplied to the liquid crystal display device 1 in response to the timing control signals.

The video signal, supplied from the video creation device 2 to the liquid crystal display device 1, is supplied to the OS process circuit 11 of the liquid crystal display device 1. The backlight turn-on signal, supplied from the video creation device 2 to the liquid crystal display device 1, is supplied to (i) the OS process circuit 11 of the liquid crystal display device 1 and (ii) the backlight 15 via the backlight drive circuit 14 of the liquid crystal display device 1.

The backlight 15 is provided behind (on an opposite surface side to a display surface) of the liquid crystal panel 13, and irradiates the liquid crystal panel 13 with light. The backlight drive circuit 14 drives the backlight 15 in response to the backlight turn-on signal (backlight control signal) supplied from the video creation device 2.

The backlight 15 includes a light source (not shown), controls the light source to turn on and off in response to the backlight turn-on signal, so as to change the turn-on period (turn-on intervals), which causes a change (adjustment) in luminance.

The liquid crystal display device 1 is thus subjected to pseudo impulse drive by insertion of a turn-off time (turn-off period) of the backlight 15 into one (1) frame period in response to the backlight turn-on signal.

According to the present embodiment, it is possible to not only attain low power consumption but also suppress the occurrence of moving image blur due to a hold drive during a gray scale transition, by (i) arranging the backlight 15 to have the turn-on period and the turn-off period (a period during which the backlight 15 turns off) and (ii) controlling the turn-on of the backlight such that an image display period and a black display period are secured.

Note that it is preferable in the present embodiment that the turn-off period (black display period) is set during the gray scale transition.

Generally, an outline of a different gray scale does not appear in an outline of a moving object as long as the backlight constantly emits light during the gray scale transition. However, as early described, in a case where (i) the turn-off period (the period during which the backlight turns off) is secured for the low power consumption and (ii) the turn-on period and the turn-off period are secured during the gray scale transition, the outline caused by the different gray scale appears in the outline of the moving object.

In view of the circumstances, the turn-off period is secured during the gray scale transition as described above. This makes it possible to eliminate a display portion due to the different gray scale (that is, intermediate gray scale different from an original gray scale) that causes moving image blur at a point where display data changes in a case where the moving image is displayed. As a result, a contour of an image can be clearly displayed.

The turn-off period of the backlight 15 is secured during the gray scale transition as much as possible, and a gray scale is kept as much stable as possible during the turn-on of the backlight 15 (that is, the backlight 15 does not emit light during the gray scale transition). This allows a reduction in appearance of the outline different from the outline of the moving object.

It is therefore preferable that the turn-on timing of the backlight 15 is controlled such that the turn-off period of the backlight 15 is secured during the gray scale transition. Further, it is preferable that the turn-on timing of the backlight 15 is controlled such that the backlight 15 turns on immediately before transmittance of the liquid crystal panel 13 changes.

Examples of the light source encompass various light emitting devices such as a light emitting diode (LED), an organic electroluminescent (EL) light emitting device, and an inorganic EL light emitting device.

Employing of a point light source as the backlight 15 allows black display (black insertion) in a desired region.

The liquid crystal display device 1 displays a video in response to the foregoing backlight turn-on signal and video signal supplied from the video creation device 2.

The OS process circuit 11 is a control circuit for controlling a drive voltage applied to the liquid crystal panel 13 via the liquid crystal panel drive circuit 12 by setting an amplitude (gray scale voltage value, overshoot quantity) of the drive voltage applied to the liquid crystal panel 13 during the gray scale transition. Specifically, the OS process circuit 11 accelerates a response speed of liquid crystal by applying an emphasis voltage to the liquid crystal panel 13 via the liquid crystal panel drive circuit 12.

The OS process circuit 11 carries out a process (OS process) for the OS drive with respect to a supplied video signal (video data signal, gray scale data).

The video signal, supplied from the video creation device 2 to the liquid crystal display device 1, is subject to the OS process in the OS process circuit 11, and then supplied as a liquid crystal panel drive signal (correction video signal) to the liquid crystal panel drive circuit 12.

The liquid crystal panel drive circuit 12 drives the liquid crystal panel 13 in response to the liquid crystal panel drive signal. The liquid crystal panel 13, which is driven in response to the liquid crystal panel drive signal, displays a video in accordance with the video signal supplied from the video creation device 2.

Note that the liquid crystal panel 13 is arranged in a manner similar to a general liquid crystal panel for use in a conventional liquid crystal display device. Therefore, detailed description and drawings for the arrangement of the liquid crystal panel 13 are omitted in this embodiment. The arrangement of the liquid crystal panel 13 is not particularly limited. A conventionally well-known liquid crystal panel can be employed, as appropriate, as the liquid crystal display panel 13.

The liquid crystal panel 13 includes, for example, an active matrix substrate, a counter substrate that faces the active matrix substrate, and a liquid crystal layer provided between the active matrix substrate and the counter substrate so as to be sealed with a sealing material. For example, a CF (color filter) substrate is employed as the counter substrate.

According to the active matrix substrate, there are provided a plurality of scanning signal lines, a plurality of data signal lines and a plurality of active devices such as TFTs (thin film transistors). Each pixel is defined by a region surrounded by a corresponding one of the plurality of scanning signal lines and a corresponding one of the plurality of data signal lines. In the liquid crystal panel 13, the pixels are arranged in a matrix manner.

The liquid crystal panel drive circuit 12 includes a scanning signal line drive circuit and a data signal line drive circuit that are not shown in FIG. 1. The scanning signal line drive circuit and the data signal line drive circuit drive the liquid crystal panel 13 in response to the timing control signals such as the clock signal and the start pulse. Specifically, the data signal line drive circuit carries out the OS drive with respect to the liquid crystal panel 13 in response to the liquid crystal panel drive signal (correction video signal) supplied from the OS process circuit 11.

The temperature sensor 16 measures a temperature of a surface of the liquid crystal panel 13, and then supplies data on the temperature to the OS process circuit 11. The temperature sensor 16 can be provided on the surface of the liquid crystal panel 13 so as to directly measure the temperature of the panel surface. Alternatively, the temperature sensor 16 is provided in a place correlated with the surface temperature of the liquid crystal panel 13 so as to indirectly measure the temperature of the panel surface. In the alternative, the surface temperature of the liquid crystal panel 13 is detected on the basis of the temperature measured in the place where the temperature sensor 16 is provided.

The temperature sensor 16 includes an A/D (analog to digital) converter (not shown) that converts, into a digital signal, an analog signal which varies in accordance with a detected temperature, and then outputs the digital signal.

As shown in FIG. 1, the OS process circuit 11 receives the video signal and the backlight turn-on signal from the video creation device 2. The OS process circuit 11 further receives data on the surface temperature of the liquid crystal panel 13 from the temperature sensor 16.

The OS drive circuit 11 carries out data conversion (OS process) for the OS process with respect to the video signal (original video data signal) supplied from the video creation device 2, in response to the video signal and the backlight turn-on signal, and preferably in accordance with the data on the surface temperature of the liquid crystal panel 13. Thereafter, the OS process circuit 11 supplies, as the liquid crystal panel drive signal, a converted video signal to the liquid crystal panel drive circuit 12.

The OS process circuit 11 changes the intensity (overshoot quantity) of the OS drive of the liquid crystal panel 13 in accordance with the turn-on period of the backlight 15. This causes a reduction in appearance of the outline of the different gray scale in the outline of the moving object.

Note that the OS process circuit 11 can obtain as needed the temperature of the panel surface from the temperature sensor 16. Alternatively, the OS process circuit 11 can obtain the temperature of the panel surface from the temperature sensor 16 in accordance with the backlight turn-on signal supplied from the video creation device 2.

Note also that the OS process circuit 11 can obtain the backlight turn-on signal directly from the video creation device 2 or the OS process circuit 11 can obtain the backlight turn-on signal via the backlight drive circuit 14.

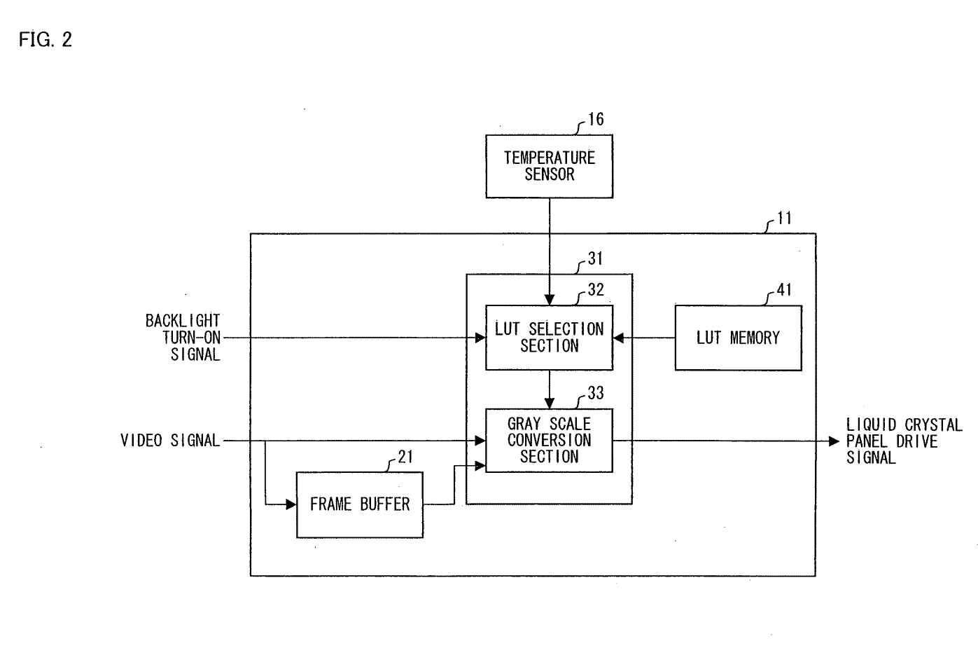

The following describes in detail a configuration and an operation of the OS process circuit 11 with reference to FIG. 2.

FIG. 2 is a block diagram schematically showing the configuration of the OS process circuit 11 in accordance with the present embodiment.

As shown in FIG. 2, the OS process circuit 11 includes a frame buffer 21 (memory), a calculation section 31 (drive voltage setting section), and an LUT memory 41 (storage section).

The frame buffer 21 is a frame memory for temporarily storing video data of a previous frame. In a case where the frame buffer 21 receives a video signal from the video creation device 2 shown in FIG. 1, the frame buffer 21 holds the video signal for one (1) frame period (that is, until the frame buffer 21 receives a video signal of a next frame). That is, the frame buffer 21 holds the video signal of the previous frame (input image of a previous vertical period).

In the LUT memory 41, a plurality of LUTs (look-up tables, conversion tables) have been stored for changing, in accordance with the turn-on period of the backlight 15, the amplitude (OS intensity, overshoot quantity) of the drive voltage to be applied during the gray scale transition in the OS drive of the liquid crystal panel 13.

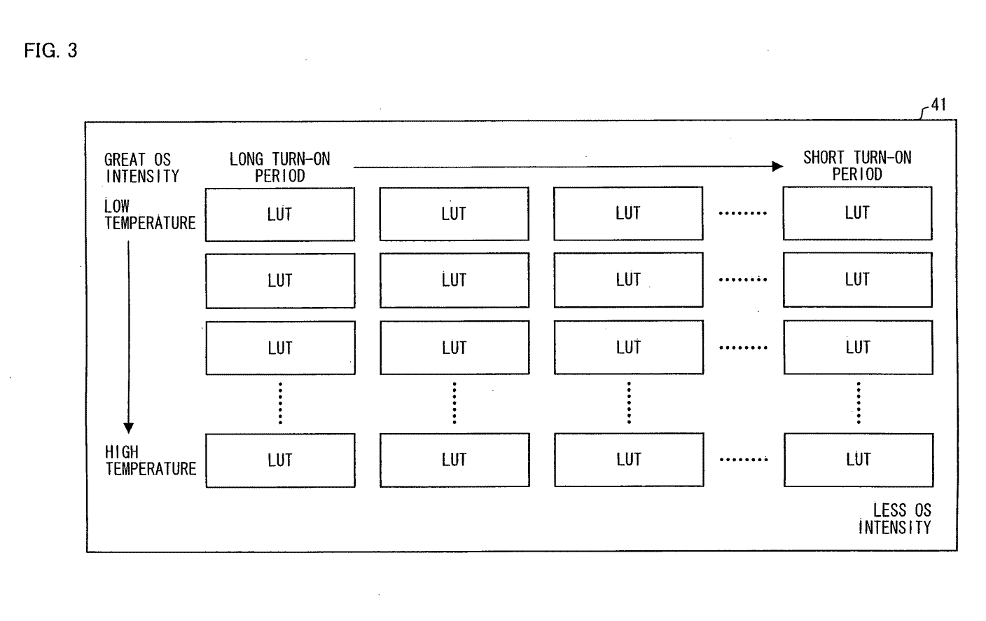

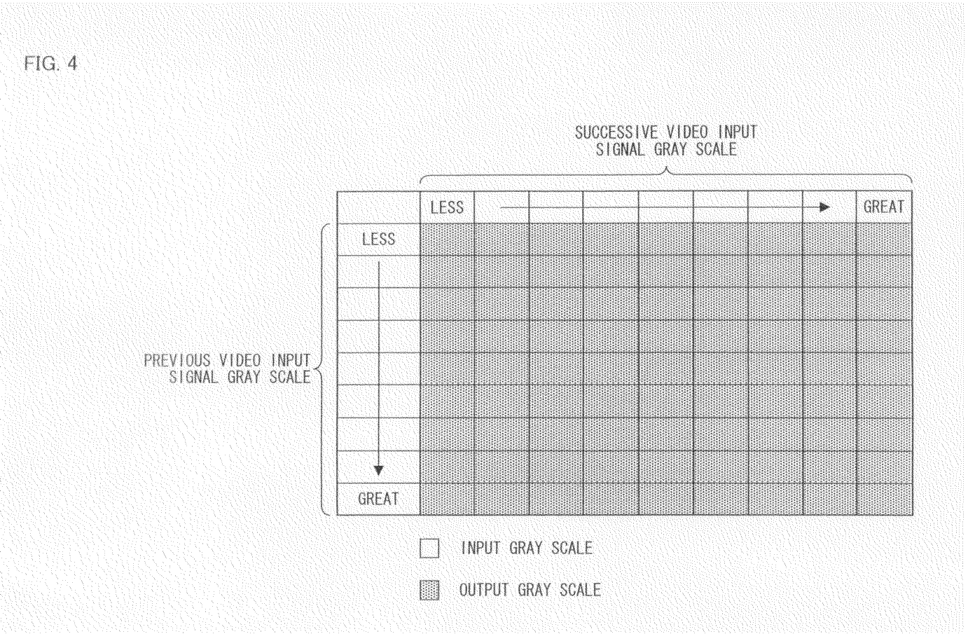

FIG. 3 is a view showing how the LUT memory 41 stores a plurality of LUTs different from one another in how much gray scales change due to respective gray scale conversions. FIG. 4 is a view showing an example of the plurality of LUTs stored in the LUT memory 41.

As shown in FIG. 3, the plurality of LUTs are stored in the LUT memory 41 so as to be associated with the turn-on periods of the backlight 15 and the surface temperatures of the liquid crystal panel 13.

As shown in FIG. 4, in each of the plurality of LUTs stored in the LUT memory 41, each amplitude (OS intensity) of drive voltages by which the liquid crystal panel 13 is driven during a corresponding gray scale transition caused by the OS drive is associated, as an output gray scale (correction gray scale) corresponding to a gray scale voltage value (drive voltage) to be supplied to the liquid crystal panel 13, with a corresponding one of combinations of video signals of a current frame (current video input signal gray scales) and video signals of a previous frame (previous video input signal gray scales).

An output gray scale of a corresponding input gray scale between adjacent two input gray scales of an LUT (that is, an output gray scale that is not stored in the LUT) is determined by use of an interpolation made based on output gray scales obtained from respective input gray scales of the LUT. This allows a reduction in size of the LUT.

The LUT memory 41 should store the plurality of LUTs. Therefore, for example, a magnetic disk device such as an HDD or an EEPROM that is a semiconductor memory is suitably employed as the LUT memory 41, because the magnetic disk device and the EEPRO can retain data even in a case where a power supply is shut off.

As shown in FIG. 2, the calculation section 31 includes an LUT selection section 32 (first calculation section) and a gray scale conversion section 33 (second calculation section).

In response to (i) the backlight turn-on signal supplied from the video creation device 2 and (ii) the data on the surface temperature of the liquid crystal panel 13 supplied from the temperature sensor 16, the LUT selection section 32 selects one of the plurality of LUTs stored in the LUT memory 41 in accordance with the turn-on period of the backlight and the surface temperature of the liquid crystal panel 13, and then supplies the one of the plurality of LUTs to the gray scale conversion section 33.

The gray scale conversion section 33 receives (i) the video signal of the current frame (current video input signal gray scale) from the video creation device 2 and (ii) the video signal of the previous frame (previous video input signal gray scale) read from the frame buffer 21.

The gray scale conversion section 33 determines an output gray scale (correction gray scale) for the OS drive from the one of the plurality of LUTs selected by the LUT selection section 32, in accordance with input values (input gray scales), i.e., the current video input signal gray scale and the previous video input signal gray scale. The gray scale conversion section 33 then supplies, as the liquid crystal panel drive signal, the output gray scale (correction gray scale) to the liquid crystal panel drive circuit 12 shown in FIG. 1.

According to the LUTs stored in the LUT memory 41, (i) the OS intensity increases as the turn-on period of the backlight 15 becomes longer and (ii) the OS intensity increases as the surface temperature of the liquid crystal panel 13 becomes lower.

Each of the plurality of LUTs stores some gray scale transitions and gray scale conversion data for the surface temperatures of the liquid crystal panel 13 so as to cover a gray scale transition range (0 to 255 gray scales in a case of bit). The gray scale conversion data has its place as adjusting a response speed of the liquid crystal panel 13. The gray scale conversion data indicates the intensity of OS. In a case of, for example, a liquid crystal panel whose drive frequency is 120 kH, it is necessary for the liquid crystal panel to have a response speed of not more than 8.3 ms irrespective of how the gray scale transition and the surface temperature of the liquid crystal panel change. However, the liquid crystal panel possibly has a response speed of not less than 8.3 ms, depending on the gray scale transition scope and/or the surface temperature of the liquid crystal panel. In view of the circumstances, it is necessary to improve the response speed of liquid crystal of the liquid crystal panel. The response speed can be rapidly improved by application of a great electric potential difference.

It is the gray scale conversion data that applies the great electric potential difference. The gray scale conversion data is obtained by measuring some gray scale transitions and surface temperatures of the liquid crystal panel 13 in the gray scale transition range (0 to 255 gray scales in the case of 8 bit) of the liquid crystal panel 13, and is then stored in the LUT.

Gray scale conversion data, obtained based on gray scale transitions and surface temperatures which are not stored in the LUT, is obtained by proportional calculation.

The above describes a normal role of OS data. According to the present embodiment, the normal role of the OS data and turn-on timing of the backlight 15 are combined. This makes it possible to alleviate adverse effect of the moving image blur (pseudo contour) caused by securing a period during which the backlight 15 (such as an LED backlight employing an LED as a light source) does not turn on.

In a case where (i) the backlight 15 is driven at a frequency of, for example, 1.20 Hz, (ii) a turn-off rate is 50% (4.15 ms) in the first half of a cycle of the backlight 15, and (ii) a turn-on rate is 50% (4.15 ms) in the second half of the cycle of the backlight 15, the liquid crystal having a response speed of not more than 4.15 ms will not cause the moving image blur (pseudo contour).

According to the present embodiment, it is possible to alleviate the moving image blur (pseudo contour) by thus changing the response speed of the liquid crystal for the turn-on rate of and the turn-off rate of the backlight 15.

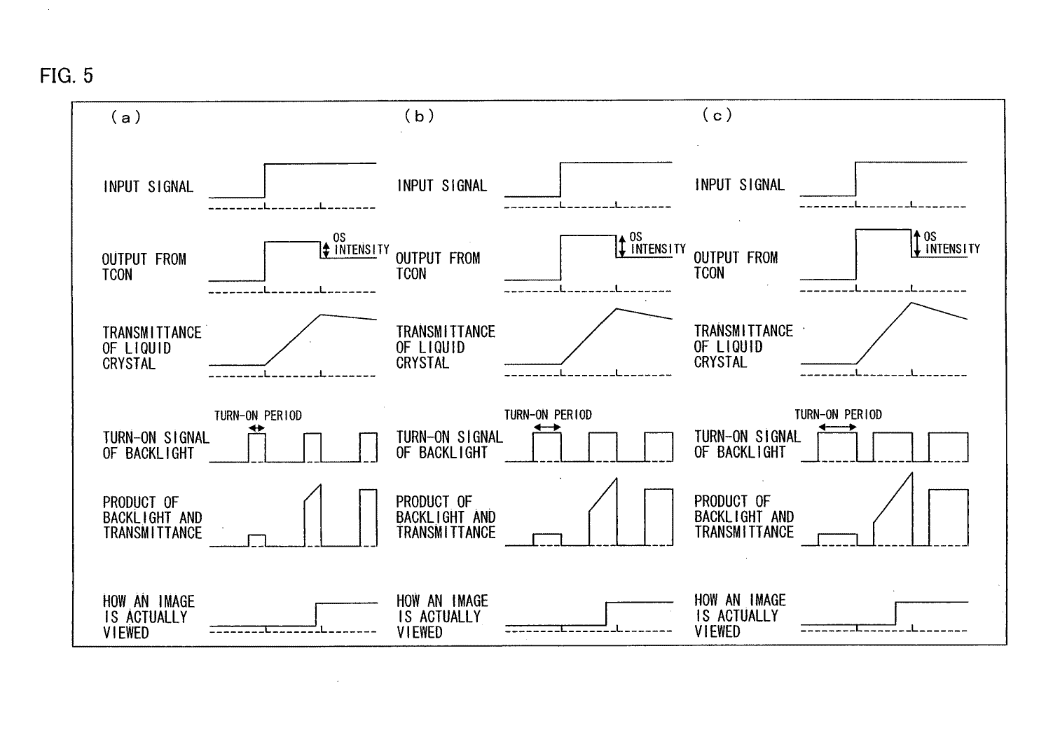

(a) through (c) of FIG. 5 each show a relationship of (i) the turn-on period of the backlight 15 of the present embodiment and (ii) the OS intensity. Specifically, (a) through (c) of FIG. 5 are timing charts (waveform diagrams) each showing input and output signals in the liquid crystal display system shown in FIG. 1, a waveform of transmittance of liquid crystal, a waveform of values obtained by integrating, over a time period during which the backlight 15 turns on, the product (indicated by “PRODUCT OF BACKLIGHT AND TRANSMITTANCE” in FIG. 5) of the transmittance of the liquid crystal and the intensity of the backlight 15 obtained when the backlight 15 turns on, and a waveform showing how an image is actually viewed on the liquid crystal panel 13 (an outline of moving object during a movie display).

As shown in any of (a) through (c) of FIG. 5, in a case where a transition occurs from a gray scale (gray scale A) to another gray scale (gray scale B different from the gray scale A), it is possible to stabilize, regardless of the turn-on period of the backlight, how the image is actually viewed at the point where the display data changes, by causing the OS intensity to become stronger as the turn-on period of the backlight increases so that the transmittance of the liquid crystal is changed.

That is, according to the present embodiment, the amplitude of the drive voltage, which is applied to the liquid crystal panel during the gray scale transition on the assumption that identical evaluation criteria are employed, becomes stronger as the turn-on period of the backlight 15 is longer. Namely, the amplitude of the drive voltage, which is applied to the liquid crystal panel during the gray scale transition under a condition where the gray scale A that has not been subjected to a transition is equal to the gray scale B that has been subjected to the transition, is increased as the turn-on period of the backlight 15 is longer. More preferably, the amplitude of the drive voltage, which is applied to the liquid crystal panel 13 during the gray scale transition under the condition where (i) the gray scale that has not been subjected to a transition is equal to the gray scale that has been subjected to the transition and (ii) detected surface temperatures of the liquid crystal panel 13 are identical, is increased as the turn-on period of the backlight 15 is longer. This prevents the outline of the different gray scale (that is, intermediate gray scale different from the original gray scale) from appearing in the outline of the moving object during movie display at the point where the display data changes. Accordingly, a viewer can clearly recognize the contour of the image.

(a) of FIG. 6 is a timing chart showing input and output signals in the liquid crystal display system shown in FIG. 1, and (b) of FIG. 6 is a timing chart showing input and output signals in the liquid crystal display system shown in FIG. 10. Each of (a) and (b) of FIG. 6 further shows (i) a waveform of transmittance of liquid crystal, (ii) a waveform of values obtained by integrating, over a time period during which the backlight turns on, the product (indicated by “PRODUCT OF BACKLIGHT AND TRANSMITTANCE” in FIG. 6) of the transmittance of the liquid crystal and an intensity of the backlight obtained when the backlight turns on, and (iii) a waveform showing how an image is actually viewed on a liquid crystal panel (an outline of a moving object during a movie display).

As shown in (a) and (b) of FIG. 6, according to the liquid crystal display system shown in FIG. 1, the outline of the different gray scale does not appear in the outline of the moving object during a turn-on period during which the outline of the intermediate gray scale appears in case of the liquid crystal display system shown in FIG. 10. Therefore, the outline of the moving object is clearly recognized in case of the liquid crystal display system shown in FIG. 1. That is, the present embodiment of the invention prevents a vague outline of the moving object from being visually recognized, so as not to cause the moving image blur in the movie display.

According to the present embodiment, it is possible to create an optimum liquid crystal panel drive signal, by providing the plurality of LUTs for changing the intensity of the OS drive in accordance with the turn-on period of the backlight 15 so that the transmittance of the liquid crystal is changed in accordance with the turn-on period of the backlight 15 when a liquid crystal drive signal is created on the basis of the video signal. In other words, the above-described problem can be solved merely by increasing, in accordance with the turn-on period of the backlight 15, the number of the LUTs to be referred.

It is possible to create a more optimum liquid crystal panel drive signal, in which temperature dependency of the response speed of the liquid crystal is considered, by thus changing the OS intensity of the OS drive, in which the identical evaluation criteria are employed, especially in accordance with the turn-on period of the backlight 15 and the surface temperature of the liquid crystal panel 13. This makes it possible to reduce or prevent occurrence of the situation in which the outline of the different gray scale is recognized in the outline of the moving object.

The present embodiment describes, as an example, a case where (i) the plurality of LUTs are thus prepared for respective combinations of the turn-on periods of the backlight 15 and the surface temperatures of the liquid crystal panel 13 and (ii) the LUT selection section 32 selects an LUT in accordance with the turn-on period of the backlight and the surface temperature of the liquid crystal panel 13.

However, the present embodiment of the present invention is not limited to this embodiment. Alternatively, a plurality of LUTs are prepared for respective turn-on periods (turn-off rate) of the backlight, and the LUT selection section 32 can select an LUT in accordance with merely the turn-on period (turn-off rate) of the backlight.

Note, however, that since a liquid crystal material has a physical property of depending greatly on temperature, the response speed of a liquid crystal display device varies depending on the temperatures of the liquid crystal material. This may cause the overshoot quantity appropriate for the turn-on period of the backlight to vary depending on ambient temperature.

In view of the circumstances, an LUT is thus selected in accordance with the turn-on period of the backlight 15 and the surface temperature of the liquid crystal panel 13. It is therefore possible to carry out an optimum OS process even in a case where the surface temperature of the liquid crystal panel 13 changes.

The present embodiment describes, as an example, a case where the output gray scale is determined by means of the plurality of LUTs. The present embodiment of the present invention is, however, not limited to this embodiment. Alternatively, the gray scale can be converted, instead of employing the plurality of LUTs, as follows. Namely, the calculation section 31 obtains an output gray scale by calculating the output gray scale by use of a formula in accordance with the turn-on period of the backlight 15.

Since the output gray scale is thus determined by means of the plurality of LUTs, it is possible to (i) arrange the liquid crystal display device at low cost and (ii) determine the output gray scale in a short period of time. In contrast, in the case where the gray scale is converted by calculation based on the formula as described above, it is possible to eliminate the LUT memory 41 from the liquid crystal display device or to reduce the memory capacity of the LUT memory 41.

Alternatively, the calculation section 31 can calculate, for example, a turn-off rate of the backlight 15 on the basis of a turn-on period of the backlight 15, and can then determine, on the basis of a calculated turn-off rate, the amplitude of a drive voltage to be applied to the liquid crystal panel 13 during a gray scale transition.

Alternatively, instead of the LUT selection section 32 and the gray scale conversion section 33, the calculation section 31 can include an LUT update section for calculating an overshoot parameter in accordance with a surface temperature of the liquid crystal panel 13 which surface temperature is detected by the temperature sensor 16 and the turn-on period (or the turn-off rate) of the backlight 15, and for updating an LUT. This arrangement makes it possible to reduce the size of the LUT. It is therefore possible to reduce the memory capacity of the LUT memory 41.

Note that a turn-on rate of the backlight 15 (how the backlight emits light) is determined by the video creation device 2. It follows that a corresponding turn-off rate of the backlight 15 is automatically determined by the video creation device 2.

For example, in a case where the backlight 15 is driven at a frequency of 120 Hz, one (1) frame period corresponds to 8.3 ms. Therefore, in a case where a turn-on rate is set within 8.3 ms, a turn-off rate is automatically determined.

As described above, the amplitude of the drive voltage to be applied to the liquid crystal panel 13 during the gray scale transition can be changed by, for example, selecting an LUT in accordance with how to be illuminated by the backlight 15. How to be illuminated by the backlight 15 is determined by the calculation section 31 based on the way for the backlight 15 to emit light which way is determined by the video creation device.

In any case, it is desirable that the calculation section 31 adjusts (sets) the amplitude of the drive voltage to be applied to the liquid crystal panel 13 during the gray scale transition such that the value, obtained by integrating over a turn-on period the product of the transmittance of the liquid crystal and the intensity of the backlight obtained when the backlight turns on, becomes a desired concentration which allows a clear recognition of the contour of the image (see (a) through (c) of FIG. 5). That is, it is desirable that the calculation section 31 sets the amplitude of the drive voltage to be applied to the liquid crystal panel 13 during the gray scale transition such that the outline of the different gray scale is not recognized in the outline of the moving object in the moving image.

The moving image blur (pseudo contour) occurs at a gray scale between a gray scale that has not been subjected to a gray scale transition and a gray scale that has been subjected to the gray scale transition. This is because the backlight 15 turns on in the course of gray scale transition of the liquid crystal. In view of the circumstances, it is possible to alleviate the moving image blur (pseudo contour) by causing the backlight 15 to turn on at a stable gray scale which is before and after gray scale transition. The alleviation of the moving image blur (pseudo contour) leads to adjustment of a gray scale concentration. The gray scale concentration is adjusted (that is, the moving image blur is alleviated) by, as described above, changing the response speed of the liquid crystal with respect to the turn-on and turn-off rates of the backlight 15.

In a case where the present embodiment of the present invention is applied to, for example, a PC (personal computer), the liquid crystal display device 1 corresponds to a liquid crystal display module, and the video creation device 2 corresponds to a CPU (central processing unit) of the PC. Note that the present embodiment of the present invention is not limited to the application to the PC. The present embodiment of the present invention is therefore applicable to various articles such as a TV and a mobile phone that include a liquid crystal display module.

FIG. 1 shows, as an example, a case where the video creation device 2 is provided separately from the liquid crystal display device 1. As shown in FIG. 1, the video creation device 2 can be provided outside the liquid crystal display device 1. Alternatively, the video creation device 2 can be included in the liquid crystal display device 1. That is, the liquid crystal display device of the present invention can be provided with the video creation device (video creation circuit).

Further, the OS process circuit 11 can be a partially or entirely large-scale integrated with other circuits, and these circuits which have been large-scaled integrated with each other can be provided on the liquid crystal panel 13. Similarly, circuits such as the liquid crystal panel drive circuit 12 and the backlight drive circuit 14 can be partially or entirely large-scale integrated with each other, and these circuits which have been large-scale integrated with each other can be provided on the liquid crystal panel 13. The video creation device 2 can also be large-scale integrated, and can be included in the liquid crystal display device 1 as described above.

The present technique is applicable to a normally black liquid crystal display device and a normally white liquid crystal display device.

The present technique is also applicable to a case where the backlight 15 is divided into a plurality of blocks (regions) and the plurality of blocks have respective different turn-on periods.

The following describes an example in which each of the blocks is controlled, with reference to (a) and (b) of FIG. 7.

In (a) of FIG. 7, (i) pixels of the liquid crystal panel 13 and (ii) divided regions (blocks) of the backlight 15 are illustrated. In (b) of FIG. 7, (i) liquid crystal panel drive signals and (ii) backlight turn-on signals indicating turn-on periods of the respective regions of the backlight 15 are illustrated.

Particularly, an area active backlight has recently gained attention as an illumination device for use in a display device or the like. In the area active backlight, there are provided a plurality of regions for illuminating light (hereinafter referred to as “illumination regions”), and brightness (luminance) of illumination light is controlled for each of the illumination regions in accordance with an image to be displayed on the liquid crystal panel. Therefore, the whole area active backlight does not have a uniform luminance, but when and how long the illumination light is illuminated are controlled for each of the illumination regions in accordance with the display data.

According to a liquid crystal display device including the area active backlight, an image is displayed by controlling the luminance of each illumination light from a corresponding one of the divided illumination regions of the area active backlight such that the each illumination light illuminates a corresponding region (hereinafter referred to as a “display region”) of the liquid crystal panel.

Therefore, such a liquid crystal display device can display a high quality image by setting an overshoot quantity (conversion quantity) for each of the display regions which is illuminated by illumination light of a corresponding one of the illumination regions in accordance with a backlight turn-on signal for the corresponding one of the illumination regions so as to carry out a corresponding OS drive.

For example, as shown in (b) of FIG. 7, in a case where the backlight 15 is divided into (m+1)×(n+1) blocks (regions) and each of the blocks corresponds to 2×2 pixels, it is possible to properly drive the liquid crystal panel 13 by supplying a turn-on signal of the backlight 15 in accordance with the liquid crystal panel drive signal.

In this case, the OS process circuit 11 can carry out the OS process by use of the plurality of LUTs. Instead of using the plurality of LUTs, the OS process circuit 11 can carry out the OS process by calculating based on a formula.

In this case, the calculation section 31 can calculate, for example as a turn-off rate, how the backlight which is divided into the regions illuminates the display regions or the pixels of the liquid crystal panel 13, and can change, in accordance with how the display regions or the pixels are illuminated, the amplitude of the drive voltage to be applied to the liquid crystal panel 13 during the gray scale transition. This makes it possible to carry out an optimal OS drive in each display region even in a case where a turn-on period of a corresponding illumination region of the backlight 15 or a surface temperature of the liquid crystal panel 13 changes.

The OS process circuit 11 and the OS process performed by the OS process circuit 11 may be realized by hardware logic, alternatively may be realized by software by using the CPU (central processing unit).

Namely, the liquid crystal display device 1 includes: the CPU for executing a control program for realizing functions of the OS process circuit 11; a ROM (read only memory) that stores the control program; a RAM (random access memory) that develops the control program; a storage device (storage medium) such as a memory that stores the control program and various data; and the like. The OS process can be realized in such a manner that the liquid crystal display device is provided with a computer-readable storage medium for storing a program code of the control program for realizing the functions, and a computer, CPU or MPU (microprocessor) reads out and executes the program code stored in the storage medium.

The storage medium is, for example, tapes such as a magnetic tape and a cassette tape, or discs such as magnetic discs (e.g. a floppy disc® and a hard disc), and optical discs (e.g. CD-ROM, MO, MD, DVD, and CD-R). Further, the storage medium may be cards such as an IC card (including a memory card) and an optical card, or semiconductor memories such as mask ROM, EPROM, EEPROM, and flash ROM.

Further, the liquid crystal display device 1 may be arranged so as to be connectable to a communication network so that the program code is supplied to the liquid crystal display device 1 through the communication network. The communication network is not particularly limited. Examples of the communication network include the Internet, intranet, extranet, LAN, ISDN, VAN, CATV communication network, virtual private network, telephone network, mobile communication network, and satellite communication network. Further, a transmission medium that constitutes the communication network is not particularly limited. Examples of the transmission medium include (i) wired lines such as IEEE 1394, USB, power-line carrier, cable TV lines, telephone lines, and ADSL lines and (ii) wireless connections such as IrDA and remote control using infrared ray, Bluetooth®, 802.11, HDR, mobile phone network, satellite connections, and terrestrial digital network. Note that the present invention can be also realized by the program code in the form of a computer data signal embedded in a carrier wave, which is the program that is electrically transmitted.

As described above, a liquid crystal display device of the present invention, including: a liquid crystal panel; and a backlight that irradiates the liquid crystal panel with light, one frame period including a turn-on period during which the backlight turns on and a turn-off period during which the backlight turns off, luminance being changed by changing turn-on intervals of the backlight, said liquid crystal display device, further comprising: a control circuit which controls a drive voltage to be applied to the liquid crystal panel by setting an amplitude of the drive voltage to be applied to the liquid crystal panel during a gray scale transition, the control circuit setting the amplitude of the drive voltage so as to be greater as the turn-on period of the backlight is longer under a condition where a gray scale that has not been subjected to a gray scale transition is equal to a gray scale that has been subjected to the gray scale transition.

Further, a method for driving the liquid crystal display device of the present invention is a method for driving a liquid crystal display device including: a liquid crystal panel, and a backlight that irradiates the liquid crystal panel with light, said method, comprising the steps of: causing one frame period to include a turn-on period during which the backlight turns on and a turn-off period during which the backlight turns off; changing luminance by changing turn-on intervals of the backlight; and setting the amplitude of the drive voltage, to be applied to the liquid crystal panel during a gray scale transition, to be greater as the turn-on period of the backlight is longer under a condition where a gray scale that has not been subjected to a gray scale transition is equal to a gray scale that has been subjected to the gray scale transition.

According to the above-described arrangement and method, applying an emphasis voltage to the liquid crystal panel as described above makes it possible to reduce appearance of an outline of a different gray scale in an outline of a moving object in a case where the backlight is turned on and off so as to change intervals at which the backlight turns on.

That is, it is preferable that the control circuit sets the amplitude of the drive voltage to be applied to the liquid crystal panel during the gray scale transition such that the outline of the different gray scale is not recognized in the outline of the moving object in the moving image.

It is preferable in the present invention that the backlight is divided into a plurality of regions having luminances that are individually controlled, and the control circuit sets, in accordance with a turn-on period of each of the plurality of regions of the backlight, the amplitude of the drive voltage for a corresponding region of the liquid crystal panel.

According to the above arrangement, it is possible to control the luminances of the respective divided regions of the backlight in accordance with an image to be displayed on the liquid crystal panel. Further, in the respective regions having the luminances that are individually controlled, it is possible to reduce appearance of the outline of the different gray scale in the outline of the moving object. On this account, the liquid crystal display device in which the backlight is divided into the plurality of regions can display a high quality image.

Specifically, the control circuit includes a memory for temporarily storing gray scale data of a previous frame which comes one frame before a current frame, and the control circuit sets the amplitude of the drive voltage in accordance with gray scale data of the current frame, the gray scale data of the previous frame read from the memory, and the turn-on period of the backlight.

That is, the control circuit carries out a gray scale transition emphasis process in accordance with the turn-on period of the backlight, and sets the amplitude of the drive voltage so as to be greater as the turn-on period of the backlight is longer under the condition where the gray scale that has not been subjected to the gray scale transition is equal to the gray scale that has been subjected to the gray scale transition, so that the transmittance of the liquid crystal is changed. This makes it possible to stabilize how an image is actually viewed at the point where the display data changes regardless of the turn-on period of the backlight.

The control circuit sets the amplitude of the drive voltage by carrying out (i) a gray scale conversion based on the gray scale data of the current frame and the gray scale data of the previous frame read from the memory so as to carry out a gray scale transition emphasis process and (ii) the gray scale conversion by use of look-up tables different from one another in the turn-on period of the backlight, so as to carry out the gray scale transition emphasis process.

More specifically, the control circuit further includes: a storage section which stores a plurality of look-up tables different from one another in how much gray scales change due to respective gray scale conversions; a selection section which selects a look-up table from the plurality of look-up tables; and a gray scale conversion section which carries out a corresponding one of the gray scale conversions by use of the look-up table selected by the selection section, the selection section selecting a look-up table in accordance with the turn-on period of the backlight from the plurality of look-up tables stored in the storage section.

Alternatively, the control circuit calculates a turn-off rate based on a turn-on period of the backlight, and sets the amplitude of the drive voltage in accordance with the turn-off rate.

As described above, the amplitude of the drive voltage to be applied to the liquid crystal panel during the gray scale transition is set by use of the look-up tables different from one another in the turn-on period of the backlight. This makes it possible to set, at short times, the amplitude of the drive voltage to be applied to the liquid crystal panel during the gray scale transition in accordance with the turn-on period of the backlight, and also makes it possible to manufacture the liquid crystal display device at low cost.

Further, as described above, the amplitude of the drive voltage to be applied to the liquid crystal panel during the gray scale transition is also set by the calculation. This makes it possible to eliminate storage means for storing the look-up tables from the liquid crystal display device, or reduce memory capacity for storing the look-up tables.

It is preferable that a timing at which the backlight turns on is controlled such that a turn-off period is secured during the gray scale transition.

It is preferable that the backlight is controlled to turn on immediately before transmittance of the liquid crystal panel changes.

Generally, the outline of the different gray scale is not recognized in the outline of the moving object provided that the backlight constantly emits light during the gray scale transition. However, in a case where the turn-on period and the turn-off period of the backlight are secured during the gray scale transition in the present invention, the outline of the different gray scale is recognized in the outline of the moving object. In view of the circumstances, the turn-off period of the backlight is set during the gray scale transition as much as possible, and a gray scale is kept as much stable as possible during the turn-on of the backlight. This allows a reduction in appearance of the outline different from the outline of the moving object.

Further, it is preferable that the liquid crystal display device further includes a temperature sensor which detects a surface temperature of the liquid crystal panel, the control circuit setting the amplitude of the drive voltage by further taking into consideration the surface temperature detected by the temperature sensor.

Further, it is preferable that the control circuit sets the amplitude of the drive voltage to be greater as the turn-on period of the backlight is longer under a condition where (i) a gray scale that has not been subjected to a gray scale transition is equal to a gray scale that has been subjected to the gray scale transition and (ii) the surface temperature of the liquid crystal panel is constant before and after the gray scale transition. It is also preferable that the control circuit sets the amplitude of the drive voltage to be greater as the surface temperature is lower.

A liquid crystal material has a physicality of depending greatly on temperature. This causes a response speed of a liquid crystal display device to change due to change in the temperature of the liquid crystal material.

However, as described above, the control circuit sets, in accordance with the surface temperature detected by the temperature sensor, the amplitude of the drive voltage to be applied to the liquid crystal panel during the gray scale transition. This makes it possible to set the amplitude of the drive voltage to be applied to the liquid crystal panel during the gray scale transition so as to be an optimal value, even in a case where the surface temperature of the liquid crystal panel changes.

The present invention is not limited to the description of the embodiments above, but may be altered by a skilled person within the scope of the claims. An embodiment based on a proper combination of technical means disclosed in different embodiments is encompassed in the technical scope of the present invention.

### INDUSTRIAL APPLICABILITY

A liquid crystal display device of the present invention is applicable to a general liquid crystal display device that changes luminance by turning on and off a backlight so as to change turn-on intervals of a backlight. The liquid crystal display device can reduce occurrence of a situation in which an outline of a different gray scale (an intermediate gray scale which is not included in an original gray scale) is recognized in an outline of a moving object. It is therefore possible to suppress deterioration in display quality of the moving image due to, for example, occurrence of an afterimage on a display screen. Accordingly, the present invention is suitably applicable to (i) a liquid crystal display device employed in various fields such as a TV, a monitor, a mobile phone, a navigation device, and a portable video game machine and (ii) a method for driving the liquid crystal display device.

### REFERENCE SIGNS LIST

1: liquid crystal display device
2: video creation device
11: OS process circuit (control circuit)
12: liquid crystal panel drive circuit
13: liquid crystal panel
14: backlight drive circuit
15: backlight
16: temperature sensor
21: frame buffer (memory)
31: calculation section
32: LUT selection section (selection section)
33: gray scale conversion section
41: LUT memory (storage means)

1. A liquid crystal display device, comprising:
a liquid crystal panel; and
a backlight that irradiates the liquid crystal panel with light, one frame period including a turn-on period during which the backlight turns on and a turn-off period during which the backlight turns off, luminance being changed by changing turn-on intervals of the backlight,
said liquid crystal display device, further comprising:
a control circuit which controls a drive voltage to be applied to the liquid crystal panel by setting an amplitude of the drive voltage to be applied to the liquid crystal panel during a gray scale transition,
the control circuit setting the amplitude of the drive voltage so as to be greater as the turn-on period of the backlight is longer under a condition where a gray scale that has not been subjected to a gray scale transition is equal to a gray scale that has been subjected to the gray scale transition.

2. The liquid crystal display device as set forth in claim 1, wherein the backlight is divided into a plurality of regions having luminances that are individually controlled, and
the control circuit sets, in accordance with a turn-on period of each of the plurality of regions of the backlight, the amplitude of the drive voltage for a corresponding region of the liquid crystal panel.

3. The liquid crystal display device as set forth in claim 1, wherein the control circuit includes a memory for temporarily storing gray scale data of a previous frame which comes one frame before a current frame, and
the control circuit sets the amplitude of the drive voltage in accordance with gray scale data of the current frame, the gray scale data of the previous frame read from the memory, and the turn-on period of the backlight.

4. The liquid crystal display device as set forth in claim 3, wherein the control circuit sets the amplitude of the drive voltage by carrying out (i) a gray scale conversion based on the gray scale data of the current frame and the gray scale data of the previous frame read from the memory so as to carry out a gray scale transition emphasis process and (ii) the gray scale conversion by use of look-up tables different from one another in the turn-on period of the backlight, so as to carry out the gray scale transition emphasis process.

5. The liquid crystal display device as set forth in claim 4, wherein the control circuit further includes:
a storage section which stores a plurality of look-up tables different from one another in how much gray scales change due to respective gray scale conversions;
a selection section which selects a look-up table from the plurality of look-up tables; and
a gray scale conversion section which carries out a corresponding one of the gray scale conversions by use of the look-up table selected by the selection section, the selection section selecting a look-up table in accordance with the turn-on period of the backlight from the plurality of look-up tables stored in the storage section.

6. The liquid crystal display device as set forth in claim 1, wherein a timing at which the backlight turns on is controlled such that a turn-off period is secured during the gray scale transition.

7. The liquid crystal display device as set forth in claim 1, wherein the backlight is controlled to turn on immediately before transmittance of the liquid crystal panel changes.

8. The liquid crystal display device as set forth in claim 1, wherein the control circuit sets the amplitude of the drive voltage such that an outline of a different gray scale is not recognized in an outline of a moving object in a moving image.

9. The liquid crystal display device as set forth in claim 1, wherein the control circuit calculates a turn-off rate based on a turn-on period of the backlight, and sets the amplitude of the drive voltage in accordance with the turn-off rate.

10. The liquid crystal display device as set forth in claim 1, further comprising:
a temperature sensor which detects a surface temperature of the liquid crystal panel,
the control circuit setting the amplitude of the drive voltage by further taking into consideration the surface temperature detected by the temperature sensor.

11. The liquid crystal display device as set forth in claim 10, wherein the control circuit sets the amplitude of the drive voltage to be greater as the turn-on period of the backlight is longer under a condition where (i) a gray scale that has not been subjected to a gray scale transition is equal to a gray scale that has been subjected to the gray scale transition and (ii) the surface temperature of the liquid crystal panel is constant before and after the gray scale transition.

12. The liquid crystal display device as set forth in claim 10, wherein the control circuit sets the amplitude of the drive voltage to be greater as the surface temperature is lower.

13. A method for driving a liquid crystal display device,
the liquid crystal display device comprising a liquid crystal panel, and a backlight that irradiates the liquid crystal panel with light,
said method, comprising the steps of:
causing one frame period to include a turn-on period during which the backlight turns on and a turn-off period during which the backlight turns off;
changing luminance by changing turn-on intervals of the backlight; and
setting the amplitude of the drive voltage, to be applied to the liquid crystal panel during a gray scale transition, to be greater as the turn-on period of the backlight is longer under a condition where a gray scale that has not been subjected to a gray scale transition is equal to a gray scale that has been subjected to the gray scale transition.
